(19) United States
(12) Patent Application Publication
(10) Pub. No.: US 2006/0207112 A1
(43) Pub. Date: Sep. 21, 2006

(54) Pocket knife

(76) Inventors: James R. Dunn, Grand Prairie, TX (US); Robert W. Fee, Savannah, GA (US)

Correspondence Address: Gordon & Jacobson, P.C.;Suite 407, 60 Long Ridge Road, Stamford, CT, 06902, US

(21) Appl. No.: 11/085,316

(22) Filed: Mar. 21, 2005

(51) Int. Cl. B67B 7/46

(52) U.S. Cl. 30/408; 30/143

(57) ABSTRACT

The present invention relates to a pocket knife having a rotation type can opener for opening a can. The rotation type can opener has a crank, a shaft, a gear and a cutting blade; the upper rim of the can is put to be infixed between the cutting blade and the gear, with the top end of the can holding the cutting blade; the crank is rotated to drive the rotation of the shaft, the rotated shaft further drives the rotation of the gear, and the rotated gear engages the upper rim of the can and drives the rotation of the can; the top end of the rotated can produces a pressure against the cutting blade so that the cutting blade first penetrates and then rotationally cuts apart the top end of the can.

### FIELD OF THE INVENTION

The present invention relates to a set of knives and, more particularly, a pocket knife.

### BACKGROUND TO THE INVENTION

There are various household kitchen utensils for different purposes. A kitchen utensil can be designed for any of such purposes; for example, knives for vegetables, for meat and for fruits, a knife having a saw-toothed blade for cutting bread, a bottle cap opener for opening the cap of a soft drink bottle, a can opener for opening a can, etc. Such various kitchen utensils are convenient for achieving various works simply and fast upon use and are easy to be bought from the markets. However, when going out for camping, barbecue, etc., it is cumbersome and inconvenient to carry all of the household kitchen utensils.

In order to solve the above-mentioned problems, a pocket knife integrating various household kitchen utensils is designed such as, for example, a Swiss army knife, which is convenient for carrying as well as being able to achieve various works simply and fast. A conventional pocket knife having a plate type can opener 62 is shown in FIG. 5. The can piercer 64 of the plate type can opener 62 is placed against the top end 69 of a can 68, with the holding part 66 thereof leaning against the lower part of the upper rim 67 of the can 68 as a fulcrum of a lever. Upon holding the body of the pocket knife 60 and applying an upward force thereon, the can piercer 64 of the plate type can opener 62 produce a downward pressure to cut the top end 69 of the can 68. However, for the plate type can opener 62 having a can opening function to be integrated into a pocket knife 60, the size thereof must be small and thus the force exerted to open the can 68 is relatively large. Also, the plate type can opener 62 having a plate structure is neither easy nor convenient for opening the can 68.

### SUMMARY OF THE INVENTION

In view of the drawbacks of the above-mentioned conventional pocket knife incorporating a plate type can opener, the pocket knife of the present invention incorporates the structure of a rotation type can opener, which can reduce the size thereof for carrying and is very effort-saving and convenient for opening a can.

The object of the present invention is to provide a pocket knife having a rotation type can opener for opening a can, which is characterized in that: the rotation type can opener has a crank, a shaft, a gear and a cutting blade; the upper rim of the can is put to be infixed between the cutting blade and the gear, with the top end of the can holding the cutting blade; the crank is rotated to drive the rotation of the shaft, the rotated shaft further drives the rotation of the gear, and the rotated gear engages the upper rim of the can and drives the rotation of the can; the top end of the rotated can produces a pressure against the cutting blade so that the cutting blade first penetrates and then rotationally cuts apart the top end of the can. Such features are very effort-saving and convenient for opening a can.

In the pocket knife as described above, the crank has a crank handle. After the crank, pivoting on the shaft, is inversely rotated by 1800, the crank can be folded on the body of the pocket knife and the crank handle can be received in the body of the pocket knife. The gear and the cutting blade are constructed in the body of the pocket knife. Also, if necessary, the pocket knife can include any one of a cutting knife, a saw-toothed knife, a knife having a groove on its blade, a bottle opener for opening the cap of a soft drink bottle, a spoon and a fork-shaped spoon (a spork), or any combination thereof. When the spoon or the spork is folded on the body of the pocket knife, the bowl of the spoon or the spork can cover the gear and the cutting blade. Such features can reduce the size of the pocket knife incorporating a rotation type can opener.

### BRIEF DESCRIPTION OF THE DRAWINGS

The structure of the present invention will now be described by referring to the accompanying drawings, in which:

FIG. 1 shows the structure of the first embodiment according to the present invention;

FIG. 2 shows the structure of the first embodiment according to the present invention from another side;

FIG. 3 shows the structure of the rotation type can opener according to the present invention;

FIG. 4 shows the structure of the second embodiment according to the present invention; and

FIG. 5 shows the conventional plate type can opener.

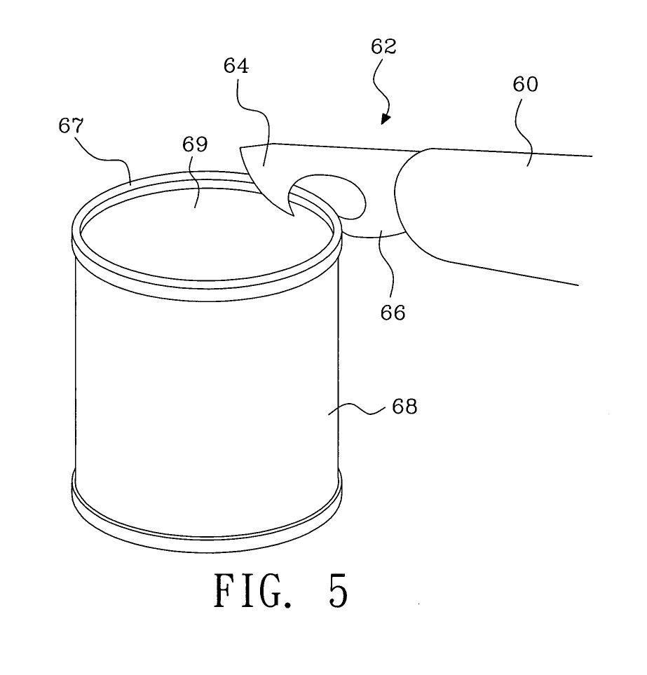

### DESCRIPTION OF PREFERRED EMBODIMENTS

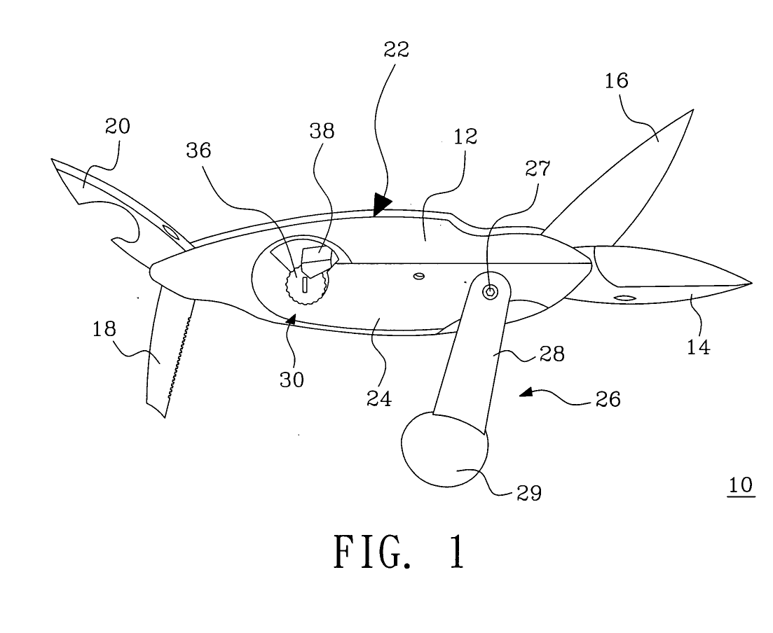

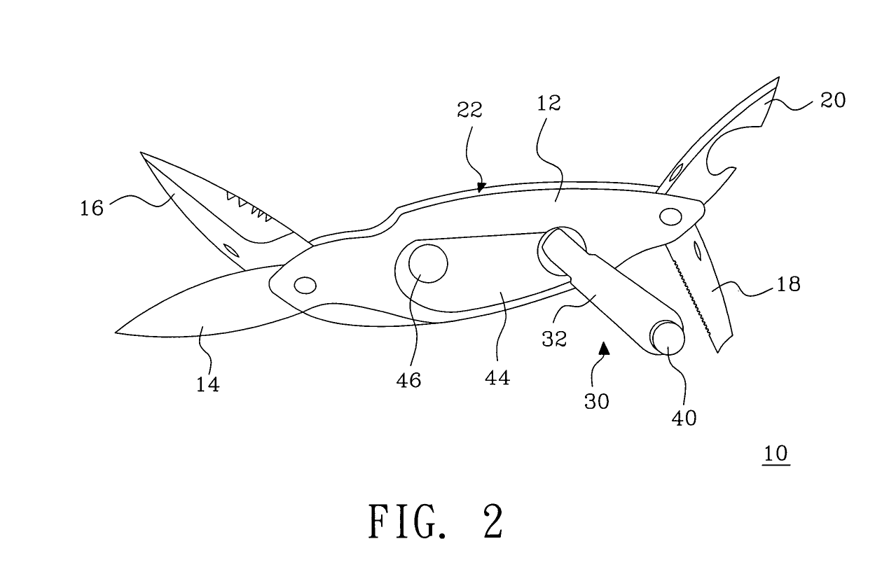

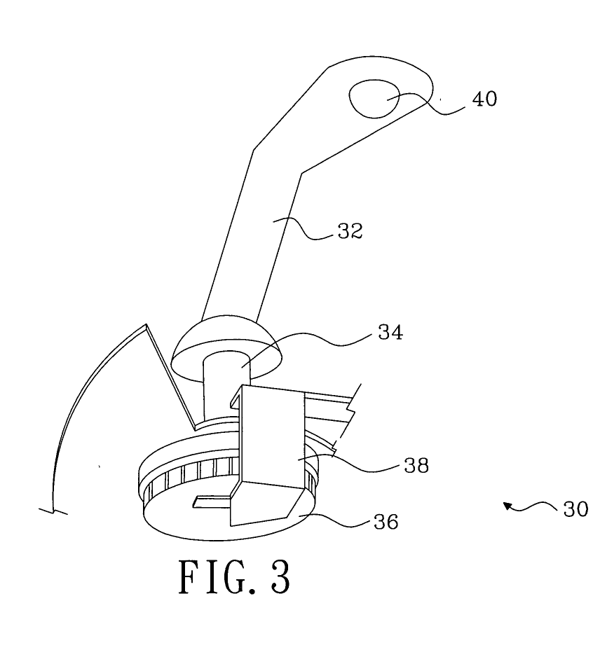

One of the preferred embodiments of the present invention will now be described by referring to the accompanying drawings, of which FIG. 1 shows the structure of the first embodiment according to the present invention, FIG. 2 shows the structure of the first embodiment according to the present invention from another side, and FIG. 3 shows the structure of the rotation type can opener according to the present invention.

In the above-mentioned drawings, the pocket knife 10 has various household kitchen utensils folded in the body 12 thereof. A groove 22 is formed in the center of the body 12. As shown in FIG. 1 and FIG. 2, the rear end of the cutting knife 14 is fixed at one side end of the body 12. The knife 14 is received in the groove 22 of the body 12 when not in use. When the cutting knife 14 is to be used for cutting, the knife 14 received in the groove 22 of the body 12, pivoting on the side end of the body 12, is drawn out by a rotation of 180° so as to perform the cutting function with the body 12 acting as a handle of the knife 14.

Similarly, the cutting knife 16 with a recess on its blade, the knife 18 having a saw-toothed blade, and the bottle cap opener 20 for opening the cap of a soft drink bottle can be used or operated in a manner similar to that of the knife 14.

A recess 24, which is formed as a flat surface, can be optionally formed on one side of the body 12. Meanwhile, the recess 24 can optionally receive a spoon 26, in which a bolt 27 inserts a hole (not shown) at the rear end of the handle 28 of the spoon 26 and is fixed at one side of the recess 24 so that the spoon 26 can pivot on the bolt 27 to be rotated back and forth by 180°. The spoon 26 is received in the recess 24 of the body 12 when not in use. When the spoon 26 is to be used for eating soup, the spoon 26 received in the recess 24 of the body 12, pivoting on the bolt 27, is drawn out by a rotation of 180° so as to perform the function of eating soup with the body 12 and the handle 28 of the spoon 26 acting as a handle of the spoon 26.

The rotation type can opener 30 for opening a can is composed of a crank 32, a shaft 34, a gear 36 and a cutting blade 38. The crank 32 and the gear 36 are pivotally connected by the shaft 34. When holding the crank handle 40 of the crank 32 to rotate the crank 32, the rotation of the shaft 34 is driven, and the rotated shaft 34 further drives the rotation of the gear 36. A recess 44, on which a hole 46 is formed, is provided on the other side of the body 12. After the crank 32, pivoting on the shaft 34, is inversely rotated by 180°, the crank handle 40 can be inserted into the hole 46 so that the crank 32 can be received on the recess 44 of the body 12. The gear 36 and the cutting blade 38 are constructed in the body 12. As shown in FIG. 1, the bowl 29 of the spoon 26 received in the recess 24 of the body 12 covers the gear 36 and the cutting blade 38.

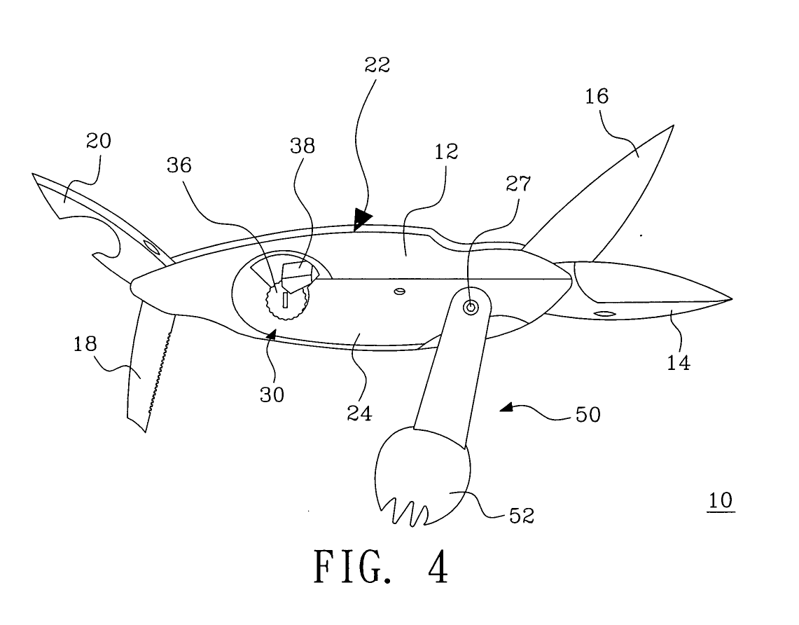

When the above-mentioned rotation type can opener 30 is used to open a can, the upper rim of the can is put to be infixed between the cutting blade 38 and the gear 36, with the top end of the can holding the cutting blade 38. When rotating the crank 32, the rotation of the gear 36 is driven, the rotated gear 36 engages the upper rim of the can and drives the rotation of the can. The top end of the rotated can produces a pressure against the cutting blade 38 so that the cutting blade 38 first penetrates the top end of the can, and then the top end of the can is cut apart under the pressure by rotating the can. FIG. 4 shows the structure of the second embodiment according to the present invention. The structural difference between the pocket knives shown in FIG. 4 and FIG. 1 is that in FIG. 4, the front end of the bowl 52 of the spoon is formed as a fork shape (a spork 50). The spork 50 having a fork-shaped bowl 52 has both spoon and fork functions and is more convenient to the users.

Accordingly, the present invention is a pocket knife having a rotation type can opener for opening a can. The upper rim of the can is put to be infixed between the cutting blade and the gear of the rotation type can opener, with the top end of the can holding the cutting blade; the crank is rotated to drive the rotation of the gear, and the rotated gear engages the upper rim of the can and drives the rotation of the can; the rotated top end of the can produces a pressure against the cutting blade so that the cutting blade first penetrates and then rotationally cuts apart the top end of the can. Thus, it is very effort-saving and convenient for opening a can.

Further, the crank has a crank handle, and after the crank, pivoting on the shaft, is inversely rotated by 180°, the crank can be folded on the body of the pocket knife and the crank handle can be received in the body of the pocket knife. The gear and the cutting blade are constructed in the body of the pocket knife, and the bowl of the spoon covers the gear and the cutting blade. Thus, the size of the pocket knife of the present invention can be reduced.

While the present invention has been shown and described with reference to a preferred embodiment thereof, and in terms of the illustrative drawings, it should not be considered as limited thereby. Various possible modifications, omissions, and alterations could be conceived of by one skilled in the art to the form and the content of any particular embodiment, without departing from the scope of the present invention.

What is claimed is:

1. A pocket knife having a rotation type can opener for opening a can, characterized in that:
said rotation type can opener has a crank, a shaft, a gear and a cutting blade; the upper rim of the can is put to be infixed between said cutting blade and said gear, with the top end of said can holding said cutting blade; said crank is rotated to drive the rotation of said shaft, the rotated shaft further drives the rotation of said gear, and the rotated gear engages the upper rim of said can and drives the rotation of said can; the top end of the rotated can produces a pressure against said cutting blade so that said cutting blade first penetrates and then rotationally cuts apart the top end of said can.

2. The pocket knife according to claim 1, wherein said crank has a crank handle; after said crank, pivoting on said shaft, is inversely rotated by 180°, said crank can be folded on the body of said pocket knife and said crank handle can be received in the body of said pocket knife.

3. The pocket knife according to claim 1, wherein said gear and said cutting blade are constructed in the body of said pocket knife.

4. The pocket knife according to claim 1, wherein said pocket knife includes any one of a cutting knife, a saw-toothed knife, a knife having a groove on its blade, a bottle opener for opening the cap of a soft drink bottle, a spoon, and a spork, or any combination thereof.

5. The pocket knife according to claim 4, wherein when the spoon or the spork is folded on the body of said pocket knife, the bowl of the spoon or the spork covers said gear and said cutting blade.
